(19) United States
(12) Patent Application Publication
(10) Pub. No.: US 2008/0102789 A1
(43) Pub. Date: May 1, 2008

(54) Apparatus and method for determining paging group size in broadband wireless communication system

(75) Inventor: Ki-Won Sung, Seoul (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 11/975,056

(22) Filed: Oct. 16, 2007

(30) Foreign Application Priority Data
Oct. 31, 2006 (KR) 2006-0106198

(51) Int. Cl. H04M 11/00; H04Q 7/20

(52) U.S. Cl. 455/406; 455/458

(57) ABSTRACT

Provided are an apparatus and method for optimizing a paging cost and a location update cost in a broadband wireless communication system. The apparatus includes: a generating unit for sequentially outputting possible combinations of the paging group size and the idle mode timer value; a first computing unit for computing a paging cost by using the output combinations; a second computing unit for computing a location update cost by using the output combinations according to a state transition diagram in which state transition occurs based on a movement path of a Mobile Station (MS); and a determining unit for determining the paging group size and the idle mode timer value so that the sum of the paging cost and the location update cost is minimized.

### CROSS-REFERENCE TO RELATED APPLICATION(S) AND CLAIM OF PRIORITY

The present application claims priority under 35 U.S.C. §119 to an application filed in the Korean Intellectual Property Office on Oct. 31, 2006 and assigned Serial No. 2006-106198, the contents of which are herein incorporated by reference.

### TECHNICAL FIELD OF THE INVENTION

The present application relates to a broadband wireless communication system, and in particular, to an apparatus and method for determining a paging group size and an idle mode timer value in a broadband wireless communication system.

### BACKGROUND OF THE INVENTION

In the next generation communication system, also known as the 4th Generation (4G) communication system, researches are actively in progress to provide a Quality of Service (QoS) with a data transfer rate of about 100 Mbps. In particular, in a Broadband Wireless Access (BWA) system, such as a wireless Local Area Network (LAN) system and a wireless Metropolitan Area Network (MAN) system, there is a research on a communication system supporting a high speed service at the same time of providing mobility and QoS. An example of such a communication system is an Institute of Electrical and Electronics Engineers (IEEE) 802.16 communication system.

The IEEE 802.16 communication system employs an Orthogonal Frequency Division Multiplexing (OFDM)/Orthogonal Frequency Division Multiple Access (OFDMA) scheme so that a broadband network can be supported in a physical channel. Researches are actively conducted so as to ensure mobility of a Mobile Station (MS) and flexibility of a network in the IEEE 802.16 communication system, and further effective services can be provided in a wireless environment where traffic distribution and call demand change rapidly.

In order for the MS to continuously receive a service while moving, there is a need to maintain information on a cell and a Base Station (BS) where the MS resides. When in a normal state, the MS continuously performs communication, and thus the communication system can maintain the information on the cell and the BS where the MS resides. When in an idle mode, the MS moves from one cell to another without performing handover. Therefore, the MS in the idle mode periodically checks a paging message, and when paging is permitted, the MS escapes from the idle mode.

A paging operation for the MS in the idle mode is performed in the unit of a paging group. In other words, the paging operation is performed by considering a predetermined number of BSs as one group. When a communication system transmits the paging message in the unit of a paging group, the MS receives the paging message and thus can check a current paging group to which the MS currently belongs. When the MS recognizes that the current paging group has changed, a location update process is performed to inform the communication system of the fact that the location of the MS has changed.

In the IEEE 802.16 system, the location update is necessary in the following cases: when the paging group has changed; when an idle mode timer is expired; when a power of an MS turns off normally; and when a Media Access Control (MAC) hash skip counter exceeds a MAC hash skip threshold. The case of power turn-off is an event generated by a user of the MS, and thus this case is not affected by a system paging policy. The case of MAC hash skip counter is defined as an option in the IEEE 802.16 standard. Therefore, in the following descriptions, the other two cases, that is, the case of paging group change and the case of idle mode timer expiration, will be explained.

FIG. 1 illustrates an example of paging groups in a conventional broadband wireless communication system. In this figure, a boundary of each paging group is indicated by a dotted line, and each circle indicates a BS.

Referring to FIG. 1, a BS located in a boundary area belongs to a plurality of paging groups in order to avoid location update which frequently occurs due to paging group change in the boundary area of each paging group,. For example, a BS-A 101 belongs to both a paging group-A 110 and a paging group-B 120.

It will be assumed that an MS moves along a path from a BS-B 103, a BS-C 105, a BS-D 107, and a BS-E 109, in that order. First, when located within a cell of the BS-B 103, the MS belongs to the paging group-B 120. Next, the MS moves to a cell area of the BS-C 105. Location update is not performed because the BS-C 105 belongs to the paging group-A 110, the paging group-B 120, the paging group-C 130, and the paging group-D 140. Next, the MS enters into a cell area of the BS-D 107, and thus belongs to the paging group-C 107. Then, location update is performed. Lastly, the MS enters into a cell area of the BS-E 109. The BS-E 109 belongs to the paging group-C 130 and the paging group-E 140, and thus location update is not performed.

In general, a paging cost and a location update cost change according to a paging group size and an idle mode timer value. The paging cost and the location update cost have a trade-off relation with each other. That is, location update is less frequently performed along with the increase of the paging group size, and as a result, the location update cost decreases. Whereas, during the paging operation, the number of BSs transmitting a paging message increases, and thus the paging cost increases. On the contrary, when the paging group size decreases, the location update cost increases, and the paging cost decreases. Therefore, there is a need for a method for minimizing the sum of the paging cost and the location update cost by properly establishing the paging group size and the idle mode timer value. In particular, to be applied to a next generation broadband wireless communication system, there is a need for a method for establishing a paging group size and an idle mode timer value wherein a paging group has a configuration of FIG. 1.

### SUMMARY OF THE INVENTION

To address the above-discussed deficiencies of the prior art, it is a primary object of the present invention to provide an apparatus and method for determining a paging group size and an idle mode timer value in a broadband wireless communication system.

The present invention also provides an apparatus and method for minimizing the sum of a paging cost and a location update cost in a broadband wireless communication system.

The present invention also provides an apparatus and method for estimating a paging cost and a location update cost according to a system model using a relative location indication scheme in a broadband wireless communication system.

According to one aspect of the present invention, there is provided a generating unit for sequentially outputting possible combinations of the paging group size and the idle mode timer value; a first computing unit for computing a paging cost by using the output combinations; a second computing unit for computing a location update cost by using the output combinations according to a state transition diagram in which state transition occurs based on a movement path of a Mobile Station (MS); and a determining unit for determining the paging group size and the idle mode timer value so that the sum of the paging cost and the location update cost is minimized.

According to another aspect of the present invention, there is provided a method of determining a paging group size and an idle mode timer in a broadband wireless communication system, comprising the steps of: computing paging costs for all possible combinations of the paging group size and the idle mode timer value; computing a location update cost for the output combination by using a state transition diagram in which state transition occurs according to a movement path of an MS; and determining the paging group size and the idle mode timer value so that the sum of the paging cost and the location update cost is minimized.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following detailed description taken in conjunction with the accompanying drawings in which, in which like reference numerals represent like parts:

FIG. 1 illustrates an example of paging groups in a conventional broadband wireless communication system;

FIG. 2 is a state transition diagram of a Mobile Station (MS) in a broadband wireless communication system according to the present invention;

FIG. 3 illustrates a cell to which an MS can move in a broadband wireless communication system according to the present invention;

FIG. 4 is a block diagram of an apparatus for determining a paging group size and an idle mode timer value in a broadband wireless communication system according to the present invention; and

FIG. 5 is a flowchart illustrating a process of determining a paging group size and an idle mode timer value in a broadband wireless communication system according to the present invention.

### DETAILED DESCRIPTION OF THE INVENTION

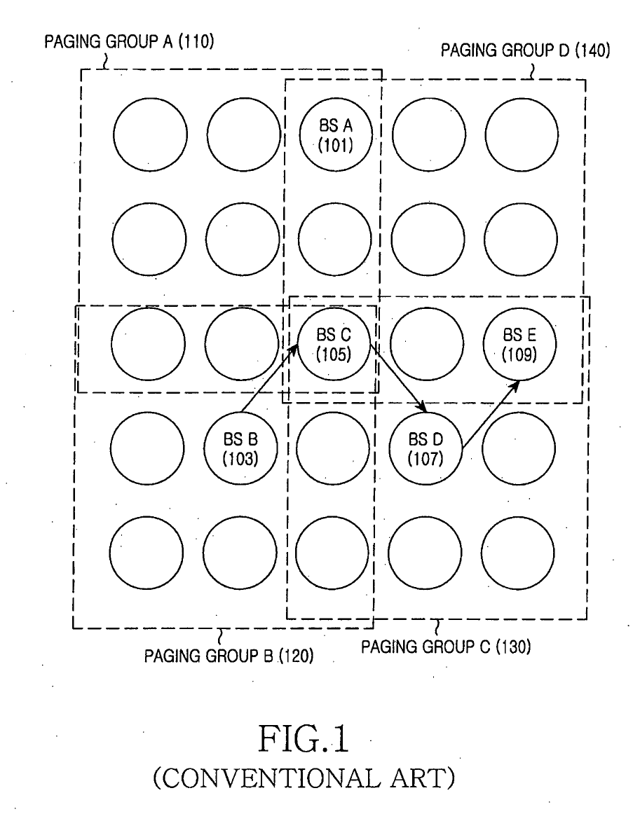

FIGS. 1 through 5, discussed herein, and the various embodiments used to describe the principles the present disclosure in this patent document are by way of illustration only and should not be construed in any way to limit the scope of the disclosure. Those skilled in the art will understand that the principles of the present disclosure may be implemented in any suitably arranged wireless communication system.

A technique of the present invention will be described hereinafter in that a paging group size and an idle mode timer are determined so that a paging cost and a location update cost are minimized in a broadband wireless communication system.

A state transition diagram of a paging group according to the present invention will be first described.

In the configuration of a paging group shown in FIG. 1, a Base Station (BS) which belongs to a plurality of paging groups is referred to as an outer BS, and a BS which belongs to one paging group is referred to as an inner BS. For example, in FIG. 1, the BS-B 103 and the BS-D 107 are inner BSs, and the BS-A 101, the BS-C 105, and the BS-E 109 are outer BSs. In this case, states are different depending on the location of a Mobile Station (MS) and are represented by four indices i1, o1, i2, and o2. In these indices, an alphabet character (i.e., i or o) denotes an inner BS or an outer BS, and a numeric character (i.e., 1 or 2) denotes whether a paging group has changed while the MS moves. That is, when the MS moves between an inner BS and an outer BS within the same paging group, the alphabet character is toggled, and when the paging group changes, the numeric character is toggled. The state transition of the MS can be represented by four cases, each of which is described in Table 1 below.

TABLE 1

| State Transition | Description |
|---|---|
| i1 -> o1 | MS moves from inner BS to outer BS, and paging group |
| | is maintained. |
| o1 -> i2 | MS moves from outer BS to inner BS, and paging group |
| | changes. |
| i2 -> o2 | MS moves from inner BS to outer BS, and paging group |
| | is maintained. |
| o2 -> i1 | MS moves from outer BS to inner BS, and paging group |
| | changes. |

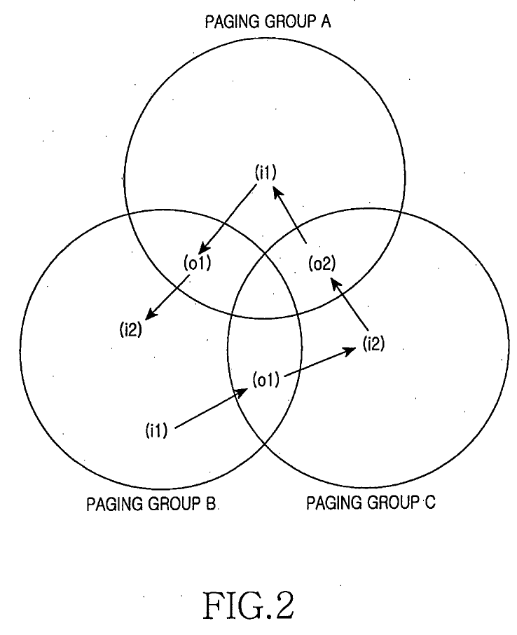

The states above do not represent absolute locations of a BS where the MS resides. Thus, the states are toggled according to a relative movement path of the MS. According to the state transition diagram, state transmission occurs based on relative information of BSs where the MS resides before and after movement. For example, when the MS moves as shown in FIG. 2, according to a rule described in Table 1 above, the state of the MS changes in the order of ‘i1→o1→i2→o2→i1→o1→i2’. It can be seen that a starting paging group and an ending paging group are identical, but states thereof are different.

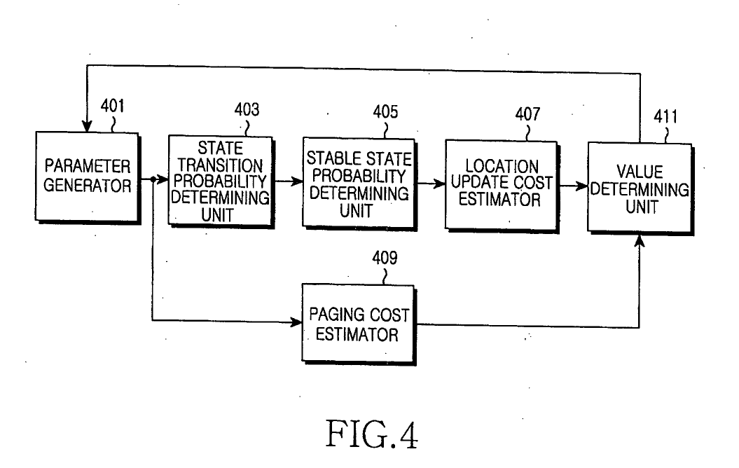

FIG. 4 is a block diagram of an apparatus for determining a paging group size and an idle mode timer value in a broadband wireless communication system according to the present invention. For convenience of explanation, the apparatus for determining a paging group size and an idle mode timer value will be also referred to as a paging group determining device.

Referring to FIG. 4, the paging group determining device includes a parameter generator 401, a state transition probability determining unit 403, a stable state probability determining unit 405, a location update cost estimator 407, a paging cost estimator 409, and a value determining unit 411.

The parameter generator 401 generates parameters which are required to optimally compute a paging group size and an idle mode timer value. The parameters may be received from an external element, or may be computed through an arithmetic operation. Examples of the parameters include a handover rate per unit time (μ_{HO}), a maximum number of times of performing paging (N_{RE}), a first paging message loss rate (P_{LOSS}), a call generation rate from an MS per unit time (λ_{MT}), a call generation rate from a network per unit time (λ_{NT}), a one-time location update cost for one BS (γ_{LU}), and a one-time paging cost for one BS (γ_{P}).

TABLE 2

| Parameter | Description | Acquisition Method |
|---|---|---|
| μ_{HO} | handover rate per unit time | computed using actual measurement or |
| | | mathematical modeling |
| N_{RE} | maximum number of times of | computed using maximum paging delay time |
| | performing paging | |
| P_{LOSS} | first paging message loss rate | defined according to service quality |
| | | standard |
| λ_{MT} | call generation rate from MS | determined according to service and |
| | per unit time | user features |
| λ_{NT} | call generation rate from | determined according to service and |
| | network per unit time | user features |
| γ_{LU} | one-time location update cost | system feature value (determined in a |
| | in one BS | design stage) |
| γ_{P} | one-time paging cost in one BS | system feature value (determined in a |
| | | design stage) |
| N_{PG} | number of BSs included in one | controlled by a value determining unit |
| | paging group | |
| T | expiration time of idle mode | controlled by a value determining unit |
| | timer | |

In Table 2 above, the handover rate per unit time (μ_{HO}) is computed based on actual measurement. However, when a situation does not allow the actual measurement, mathematical modeling may be used. For example, if a circular cell having a cell radius of D is used, the handover rate per unit time (μ_{HO}) can be computed using Equations (1) and (2) below.

$${D}_{avg} = {\int }_{0}^{D} {\int }_{0}^{2 π} \frac{{( {D}^{2} + {r}^{2} - 2 Dr cos θ )}^{1 / 2}}{2 π D} d θ d r \qquad ( 1 )$$

In Equation (1), D_{avg} denotes an average of distances from a location in a cell to a cell boundary, D denotes a cell radius, and r and θ each denote a location in a cell represented by a cylindrical coordinate system.

If an MS having average speed of v is deviated from a cell by linear movement, then the handover rate per unit time (μ_{HO}) can be computed using Equation (2) below.

$${μ}_{HO} = \frac{ν}{{D}_{avg}} \qquad ( 2 )$$

In Equation (2), D_{avg} denotes an average of distances from a location in a cell to a cell boundary (result of Equation (1) above), and v denotes an average movement speed of the MS.

In Table 2 above, the paging group size N_{PG} and the timer expiration time T are values to be optimized in the present invention. Hence, the parameter generator 401 modifies these two values under the control of the value determining unit 411.

Specifically, the parameter generator 401 obtains the parameters described in Table 2 above and outputs them to the state transition probability determining unit 403 and the paging cost estimator 409. The parameters may have different values in another embodiment.

On the basis of the state transition diagram of FIGS. 2, the state transition probability determining unit 403 generates a state transition probability matrix as expressed by Equation (3) below.

$${P}_{state} = [ \begin{matrix}{P}_{i 1 , i 1} & {P}_{i 1 , o 1} & {P}_{i 1 , i 2} & {P}_{i 1 , o 2} \\ {P}_{o 1 , i 1} & {P}_{o 1 , o 1} & {P}_{o 1 , i 2} & {P}_{o 1 , o 2} \\ {P}_{i 1 , i 1} & {P}_{i 2 , o 1} & {P}_{i 2 , i 2} & {P}_{i 2 , o 2} \\ {P}_{o 2 , i 1} & {P}_{o 2 , o 1} & {P}_{o 2 , i 2} & {P}_{o 1 , o 2}\end{matrix} ] \qquad ( 3 )$$

In Equation (3), P_{i,j} denotes a probability of state transition from state i to state j.

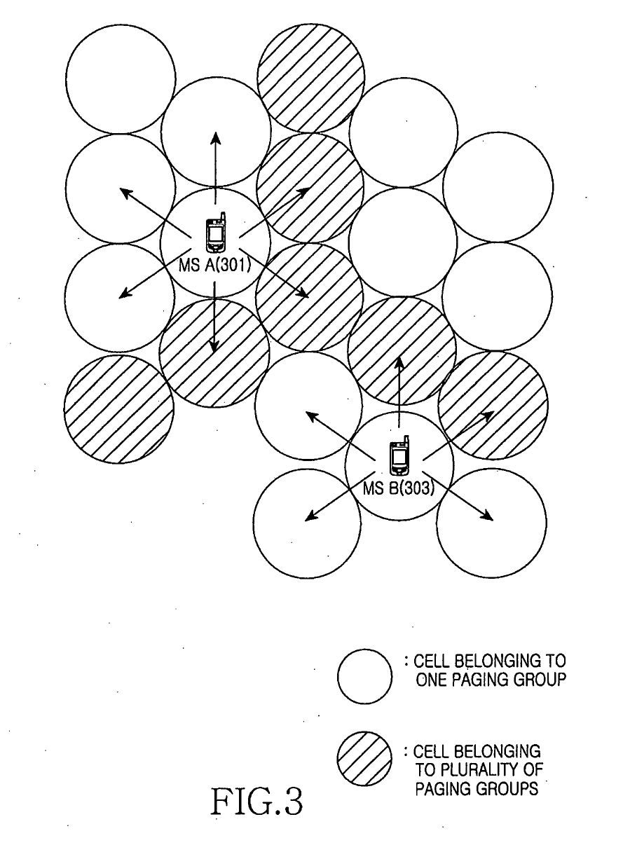

It will be assumed that a cell A is adjacent to M neighboring cells, each of which is B₁, B₂, . . . , B_{M}. For example, if a paging group is configured as shown in FIG. 3, the MS-A 301 and the MS-B 303 respectively have 6 and 5 neighboring cells.

In this case, coefficients used to compute the state transition probability are defined as described in Table 3 below.

TABLE 3

| Coefficient | Description |
|---|---|
| I^{A}_{Si,m} | Cell A and neighboring cell Bm belong to the same |
| | paging group. |
| | If Bm belongs to one paging group, set to ‘1’, |
| | otherwise, set to ‘0’. |
| I^{A}_{So,m} | Cell A and neighboring cell Bm belong to the same |
| | paging group. |
| | If Bm belongs to a plurality of paging groups, set to ‘1’, |
| | otherwise set to ‘0’. |
| I^{A}_{Di,m} | Cell A and neighboring cell Bm belong to different paging |
| | groups. |
| | If Bm belongs to one paging group, set to ‘1’, |
| | otherwise, set to ‘0’. |
| I^{A}_{Do,m} | Cell A and neighboring cell Bm belong to different paging |
| | groups. |
| | If Bm belongs to a plurality of paging groups, set to ‘1’, |
| | otherwise set to ‘0’. |

By using the coefficients described in Table 3 above, a state transition probability of an MS located in the cell A can be computed. For example, when a paging group is configured as shown in FIG. 3, the state transition probability of the MS-A 301 can be expressed by Equation (4) below.

$${P}_{i 1 , i 1}^{A} = {P}_{i 2 , i 2}^{A} = {\sum }_{m = 1}^{M} {I}_{Si , m}^{A} \cdot {P}_{HO , m}^{A} \\ {P}_{i 1 , i 2}^{A} = {P}_{i 2 , i 1}^{A} = {\sum }_{m = 1}^{M} {I}_{Di , m}^{A} \cdot {P}_{HO , m}^{A} \\ {P}_{i 1 , o 1}^{A} = {P}_{i 2 , o 2}^{A} = {\sum }_{m = 1}^{M} {I}_{So , m}^{A} \cdot {P}_{HO , m}^{A} \\ {P}_{i 1 , o 2}^{A} = {P}_{i 2 , o 1}^{A} = {\sum }_{m = 1}^{M} {I}_{Do , m}^{A} \cdot {P}_{HO , m}^{A} \qquad ( 4 )$$

In Equation (4), P^{A}_{i,j} denotes a probability that the MS-A 301 experiences a state transition from state i to state j, and P^{A}_{HO,m} denotes a probability that the MS-A 301 handovers to its neighboring cell Bₘ. i1, i2, o1, o2 are indices indicating a state of the MS. The handover probability P^{A}_{HO,m} is computed for each neighboring cell. When the handover probability P^{A}_{HO,m} is not easily computed, it can be assumed to be 1/M. Then, as for the MS-A 301 of FIG. 3, P^{A}_{i1,i1} is 1/2(3/6), P^{A}_{i1,o1} is 1/2(3/6), P^{A}_{i1,i2} is 0, and P^{A}_{i1,o2} is 0.

Such computation is performed for all cells within one paging group, and then state transition probabilities of inner BS cells and state transition probabilities of outer BS cells are respectively averaged. As a result, a state transition probability matrix Pₛₜₐₜₑ of the communication system is generated as expressed by Equation (3) above.

Specifically, the state transition probability determining unit 403 generates an average state transition probability of the communication system, and outputs the state transition probability matrix Pₛₜₐₜₑ to the stable state probability determining unit 405. The state transition probability P_{i,j} may vary depending on the paging group size.

The stable state probability determining unit 405 receives the state transition probability matrix Pₛₜₐₜₑ from the state transition probability determining unit 403, and computes a stable state probability. That is, a probability that an MS is in a certain state at a certain time point is computed. For respective states, if the stable state probabilities are πₒ₁, πᵢ₁, πₒ₂, and πᵢ₂, Equation (5) below is satisfied.

$${\sum }_{j} {π}_{j} = 1 \\ Π = Π \cdot {P}_{state} \qquad ( 5 )$$

In Equation (5), πⱼ denotes a stable state probability for a state j, π denotes a stable state probability vector [π₀₁, nᵢ₁, πₒ₂, πᵢ₂], and Pₛₜₐₜₑ denotes the state transition probability matrix expressed by Equation (3) above.

When an initially determined stable state probability is repeatedly multiplied by the state transition probability, the stable state probability is converged to a further stable value along with the increase of the number of times of repetition. In this manner, the stable state probability π can be computed which represents an average location probability of the MS.

The location update cost estimator 407 receives the stable state probability vector from the stable state probability determining unit 405 and thus computes a location update cost. The location update cost is the sum of a location update cost resulted from paging group change and a location update cost resulted from idle mode timer expiration, which can be expressed as Equation (6).

C_{LU}=γ_{LU}·(R_{LU,PG}+R_{LU,TU}) (6)

In Equation (6), λ_{LU} denotes a one-time location update cost for one BS, R_{LU,PG} denotes a location update rate resulted from paging group change, and R_{LU,TU} denotes a location update rate resulted from idle mode timer expiration.

In Equation (6), the location update rate R_{LU,PG} resulted from paging group change is expressed as Equation (7) below.

R_{LU,PG}=μ_{HO}[πₒ₁(p_{o1,i2}+p_{o1,o2})+πₒ₂(p_{o2,i1}+p_{o2,o1})] (7)

In Equation (7), λ_{HO} denotes a handover probability, nᵢ denotes a stable state probability for state i, and P_{i,j} denotes a probability that the MS transitions from state i to state j.

The paging group of the MS changes when handover occurs from an outer BS cell to an inner BS cell of another paging group. Therefore, the location update rate R_{LU,PG} can be computed in the following manner. First, the stable state probabilities πₒ₁ and πₒ₂ are multiplied by a change probability that a paging group changes in a certain state. Herein, the change probability is p_{o1,i2}+p_{o1,o2} in case πₒ₁ and p_{o2,i1}+p_{o2,o1} in case of πₒ₂. Thereafter, the multiplication result is multiplied by a handover probability for each state. As a result, the location update rate R_{LU,PG} resulted from paging group change is computed.

In addition, in Equation (6), the location update rate R_{LU,TU} resulted from idle mode timer expiration can be expressed as Equation (8) below.

$${R}_{LU , TU} = {λ}_{E} \cdot E [ {X}_{TU} ] = {λ}_{E} \cdot \frac{1}{p ( {T}_{TU} < T )} = {λ}_{E} \cdot \frac{1}{1 - {e}^{- {λ}_{E} T}} \qquad ( 8 )$$

In Equation (8), λ_{E} denotes the sum (R_{LU,PG}+λ_{MT}+λ_{NT}) of a paging group change rate resulted from the movement of MS, a call generation rate of the MS, and a call generation rate of a network, that is, λ_{E} denotes a reset rate of an idle mode timer per unit time. In addition, X_{TU} denotes a random variable for the number of times of timer termination while the idle mode timer is reset, T_{TU} denotes a random variable for a time period when the idle mode timer is maintained without being reset, and T denotes the idle mode timer value.

Since X_{TU} depends on geometric distribution having a success probability of p (T_{TU}<T), a location update rate resulted from timer expiration per unit time can be computed by using E[X_{TU}] of Equation (8).

The paging cost estimator 409 receives a parameter from the parameter generator 401 and thus computes a paging cost for one paging group. For example, the paging cost can be expressed as Equation (9) below.

$${C}_{p} = {λ}_{MT} \cdot {γ}_{PG} \cdot {N}_{PG} \cdot {\sum }_{i = 1}^{{N}_{RE}} {( {P}_{LOSS} )}^{i - 1} \qquad ( 9 )$$

In Equation (9), λ_{MT} denotes a call generation rate from an MS, γ_{PG} denotes a one-time paging cost of one BS, N_{PG} denotes the number of BSs belonging to one paging group, N_{RE} denotes a maximum number of times of performing paging, and P_{LOSS} denotes a loss rate of a first paging message.

The value determining unit 411 receives location update cost information from the location update cost estimator 407, stores paging cost information received from the paging cost estimator 409, and controls the parameter generator 401 so as to modify parameters for computing the location update cost and the paging cost. Thereafter, these location update cost and paging cost are compared with next computed location update cost and paging cost, and thus the paging group size N_{PG} and the timer expiration time T are determined.

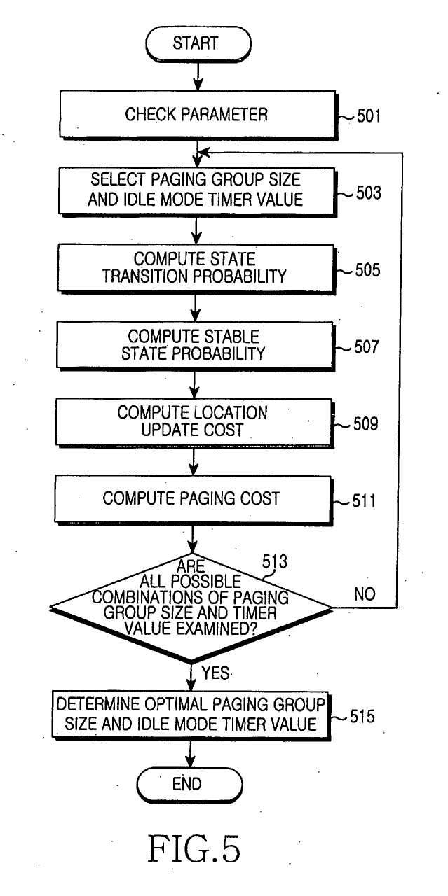

FIG. 5 is a flowchart illustrating a process of determining a paging group size and an idle mode timer value performed by a paging group determining device in a broadband wireless communication system according to the present invention.

Referring to FIG. 5, in step 501, parameters required to determine a paging group size and an idle mode timer value are checked. Examples of the parameters include a handover rate per unit time (μHO), a maximum number of times of performing paging (NRE), a first paging message loss rate (PLOSS), a call generation rate from an MS per unit time (λMT), a call generation rate from a network per unit time (λNT), a one-time location update cost for one BS (γLU), and a one-time paging cost for one BS (γP).

In step 503, the paging group size and the idle mode timer value are selected. If this is not the first time of selecting the two values, the values are selected such that combination of the two values is different from previously selected combination.

After selecting the paging group size and the idle mode timer value, in step 505, an average state transition probability of the communication system is computed. Specifically, an average state transition probability of the communication system is obtained in such a manner that computation using Equation (4) above is performed for all cells within one paging group and the computation results are averaged. Herein, a state transition probability is computed for each state transition case described in Table 1 above, and is configured in the matrix format expressed by Equation (3) above.

After computing the state transition probability, in step 507, an average stable state probability of the communication system is computed by using the state transition probability. Specifically, an initial setup is performed as expressed by Equation (5) above so that the stable state probability for each state is set to 1, and thereafter the state transition probability is repeatedly multiplied by the stable state probability until it is converged to a stable value. As a result, a desired stable state probability is obtained.

After computing the stable state probability, in step 509, a location update cost per unit time for one paging group is computed by using the stable state probability. Specifically, the location update rate R_{LU,PG} resulted from paging group change and the paging group change rate P_{LU,TU} resulted from idle mode timer expiration are obtained using Equations (7) and (8) above, and the location update cost is computed using Equation (6) above.

In step 511, a paging cost per unit time for one paging group is computed by using the parameters checked in step 501. That is, the paging cost is computed using Equation (9) above.

In step 513, it is checked whether a system cost (i.e., the location update cost and the paging cost) is computed for all possible combinations of the paging group size and the idle mode timer value.

If the system cost is not computed for all possible combinations, step 503 is performed again for another combination.

Otherwise, in step 515, the paging group size and the idle mode timer value are optimally selected so that the sum of the location update cost and the paging cost is minimized. Then, the procedure is ended.

According to the present invention, a paging group size and an idle mode timer value can be determined in a broadband wireless communication system. The determination of the paging group size and the idle mode timer value is performed in a system design stage, and these values are used as constant values during system operation.

During system operation, if the paging group size and the idle mode timer value can be controlled, the paging group size and the idle mode timer value can be determined according to the aforementioned configuration and procedure by the use of the parameters described in Table 2 above.

As such, the paging group size and the idle mode timer value are determined in consideration of a system cost in the broadband wireless communication system, and the paging group size and the idle mode timer value can be established so that the paging cost and the location update cost can be minimized.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for determining a paging group size and an idle mode timer value in a broadband wireless communication system, comprising:
a generating unit for outputting possible combinations of the paging group size and the idle mode timer value;
a first computing unit for computing a paging cost by using the possible combinations;
a second computing unit for computing a location update cost by using the possible combinations according to a state transition diagram in which state transition occurs based on a movement path of a mobile station; and
a determining unit for determining the paging group size and the idle mode timer value so that the sum of the paging cost and the location update cost is minimized.

2. The apparatus of claim 1, wherein, in the state transmission diagram, state transition occurs based on relative information associated with a base station where the mobile station resides before and after movement.

3. The apparatus of claim 2, wherein, in the state transition diagram, state transition occurs when the number of a paging group where the mobile station belongs changes along with the movement of the mobile station or when the paging group where the mobile station belongs changes.

4. The apparatus of claim 2, wherein the state of the state transition diagram includes at least one selected from a group consisting of a first state i1, a second state o1, a third state i2, and a fourth state o2, where ‘i’ denotes that the mobile station belongs to one paging group, ‘o’ denotes the mobile station belongs to a plurality of paging groups, and ‘1’ and ‘2’ are toggled whenever the paging group where the mobile station belongs changes.

5. The apparatus of claim 1, wherein the first computation unit computes a paging cost per unit time using Equation:
$${λ}_{MT} \cdot {γ}_{PG} \cdot {N}_{PG} \cdot {\sum }_{i = 1}^{{N}_{RE}} {( {P}_{LOSS} )}^{i - 1} ,$$
where λMT denotes a call generation rate from the mobile station, γPG denotes a one-time paging cost of one base station, NPG denotes the number of base stations belonging to one paging group, NRE denotes a maximum number of times of performing paging, and PLOSS denotes a loss rate of a first paging message.

6. The apparatus of claim 1, wherein the second computation unit comprises:
a state transition probability determining unit for forming a matrix by computing all possibilities of state transition from state i to state j according to the state transition diagram;
a stable state probability determining unit for computing a stable state probability for each state by using the matrix formed by the state transition probability determining unit; and
a location update cost estimator for computing a location update cost per unit time by using the stable state probabilities computed by the stable state probability determining unit and by using the idle mode timer value.

7. The apparatus of claim 6, wherein the location update cost estimator computes a first location update cost depending on the paging group size by using the stable state probabilities, computes a second location update cost depending on the idle mode timer value, and computes a location update cost per unit time by adding the first location update cost and the second location update cost.

8. The apparatus of claim 7, wherein the first location update cost is computed using Equation:
λ_{LU}·μ_{HO}[πₒ₁(p_{o1,i2}+p_{o1,o2})+πₒ₂(p_{o2,i1}+p_{o2,o1})],
where γLU denotes a one-time location update cost for one base station, μHO denotes a handover probability, πi denotes a stable state probability for state i, and Pi,j denotes a probability that the mobile station transitions from state i to state j.

9. The apparatus of claim 7, wherein the second location update cost is computed using Equation:
$${γ}_{LU} \cdot {λ}_{E} \cdot E [ {X}_{TU} ] = {γ}_{LU} \cdot {λ}_{E} \cdot \frac{1}{p ( {T}_{TU} < T )} = {γ}_{LU} \cdot {λ}_{E} \cdot \frac{1}{1 - {e}^{- {λ}_{E} T}} ,$$
where γLU denotes a one-time location update cost for one base station, λE denotes a reset rate of an idle mode timer per unit time, XTU denotes a random variable for the number of times of terminating a timer while the idle mode timer is reset, TTU denotes a random various for a time period when the idle mode timer maintains without being reset, and T denotes the idle mode timer value.

10. A method of determining a paging group size and an idle mode timer in a broadband wireless communication system, comprising the steps of:
computing paging costs for all possible combinations of the paging group size and the idle mode timer value;
computing a location update cost for each possible combination by using a state transition diagram in which state transition occurs according to a movement path of a mobile station; and
determining the paging group size and the idle mode timer value so that the sum of the paging cost and the location update cost is minimized.

11. The method of claim 10, wherein, in the state transmission diagram, state transition occurs based on relative information included in a base station where the mobile station resides before and after movement.

12. The method of claim 11, wherein, in the state transition diagram, state transition occurs when the number of paging groups where the mobile station belongs changes along with the movement of the mobile station or when a paging group where the mobile station belongs changes.

13. The method of claim 11, wherein the state of the state transition diagram includes at least one selected from a group consisting of a first state i1, a second state o1, a third state i2, and a fourth state o2, where ‘i’ denotes that the mobile station belongs to one paging group, ‘o’ denotes the mobile station belongs to a plurality of paging groups, and ‘1’ and ‘2’ are toggled whenever the paging group where the mobile station belongs changes.

14. The method of claim 10, wherein the paging cost per unit time is computed using Equation:
$${λ}_{MT} \cdot {γ}_{PG} \cdot {N}_{PG} \cdot {\sum }_{i = 1}^{{N}_{RE}} {( {P}_{LOSS} )}^{i - 1} ,$$
where λ_{MT} denotes a call generation rate from the mobile station, λPG denotes a one-time paging cost of one base station, NPG denotes the number of base stations belonging to one paging group, NRE denotes a maximum number of times of performing paging, and PLOSS denotes a loss rate of a first paging message.

15. The method of claim 10, wherein the step of computing a location update cost comprises:
forming a matrix by computing all possibilities of state transition from state i to state j according to the state transition diagram;
computing a stable state probability for each state by using the matrix formed by the state transition probability determining unit; and
computing a location update cost per unit time by using the stable state probabilities computed by the stable state probability determining unit and by using the idle mode timer value.

16. The method claim 15, wherein the step of computing a location update cost comprises:
computing a first location update cost depending on the paging group size by using the stable state probabilities;
computing a second location update cost depending on the idle mode timer value; and
computing a location update cost per unit time by adding the first location update cost and the second location update cost.

17. The method of claim 16, wherein the first location update cost is computed using Equation:
λ_{LU}·μ_{HO}[πₒ₁(p_{o1,i2}+p_{o1,o2})+πₒ₂(p_{o2,i1}+p_{o2,o1})],
where γLU denotes a one-time location update cost for one base station, μHO denotes a handover probability, πi denotes a stable state probability for state i, and Pi,j denotes a probability that the mobile station transitions from state i to state j.

18. The method of claim 16, wherein the second location update cost is computed using Equation:
$${γ}_{LU} \cdot {λ}_{E} \cdot E [ {X}_{TU} ] = {γ}_{LU} \cdot {λ}_{E} \cdot \frac{1}{p ( {T}_{TU} < T )} = {γ}_{LU} \cdot {λ}_{E} \cdot \frac{1}{1 - {e}^{- {λ}_{E} T}} ,$$
where γLU denotes a one-time location update cost for one base station, λE denotes a reset rate of an idle mode timer per unit time, XTU denotes a random variable for the number of times of terminating a timer while the idle mode timer is reset, TTU denotes a random various for a time period when the idle mode timer maintains without being reset, and T denotes the idle mode timer value.
